(19) United States
(12) Patent Application Publication
(10) Pub. No.: US 2012/0166022 A1
(43) Pub. Date: Jun. 28, 2012

(54) METHOD FOR MONITORING AIR POLLUTION AND SYSTEM FOR THE SAME

(75) Inventors: Seung Joon KWON, Seoul (KR); Sung Woong Shin, Daejeon (KR)

(73) Assignee: Electronics and Telecommunications Research Institute, Daejeon (KR)

(21) Appl. No.: 13/307,292

(22) Filed: Nov. 30, 2011

(30) Foreign Application Priority Data
Dec. 23, 2010 (KR) 10-2010-0133512

(51) Int. Cl. G05D 1/00

(52) U.S. Cl. 701/2

(57) ABSTRACT

An air pollution monitoring method and system is disclosed. The air pollution monitoring method of the present invention may include receiving result information corresponding to a mission of an aircraft from the aircraft, generating air pollution index values, their distribution, and three-dimensional geographic spatial information about a corresponding ground area using the result information corresponding to the mission of the aircraft and visualizing the generated data, generating a mission command of the aircraft using the result information corresponding to the mission of the aircraft, and displaying the generated three-dimensional geographic spatial information and transmitting the generated mission command to the aircraft.

### CROSS-REFERENCE TO RELATED PATENT APPLICATION

This application claims the benefit of Korean Patent Application No. 10-2010-0133512, filed on Dec. 23, 2010, in the Korean Intellectual Property Office, the disclosure of which is incorporated herein in its entirety by reference.

### BACKGROUND OF THE INVENTION

1. Field of the Invention

The present invention relates to a method for monitoring air pollution and a system for the same and, more particularly, to a method for monitoring air pollution and a system for the same, which monitors air pollution using air pollution data for various non-stationary ground areas and spatial information about the corresponding ground areas.

2. Description of the Related Art

An air pollution monitoring method, which is intended to actively and efficiently deal with environmental pollution problems such as global warming caused by reckless discharge of air pollutants such as carbon monoxide, carbon dioxide, etc., has become a very important topic all over the world. In particular, various regulations and restrictions such as regulation of total emission of greenhouse gases, carbon emission trading system, etc. will be in force throughout the world so as to prevent the problems of greenhouse gases including carbon dioxide discharge, and thus the importance of establishing and implementing an effective air pollution monitoring technique has become more significant. Here, the air pollution monitoring technique is a key element needed to achieve a long-term global goal for emission reductions.

A technique for collecting information on dust and air pollution in real time using a stationary atmospheric gas sensor pre-installed in a place, where the emission of pollutants is expected, and displaying the pollution level on image data such as a map using a computer is the main key element of an existing air pollution monitoring system. Recently, an ambient air monitoring station is installed in a city or industrial area where various pollutants are generated such that the concentrations of air pollutants measured at the ambient air monitoring station are displayed as measurement values and notified to users.

However, such an air pollution monitoring system can only create a simple pollution map using the data obtained at the monitoring system installed in a fixed location. That is, the existing air pollution monitoring system is used only as a type of air warning system which stores only the pollution level for each air pollutant, which is the atmospheric state of the past at the present time, performs a series of statistical analysis processes, and sends out an alert to the citizens without real-time visualization on air pollution information of various geographic locations. As a result, the existing air pollution monitoring system has limitations in terms of atmospheric environment assessment for utilization and effectiveness of atmospheric environment information, establishment of atmospheric environment improvement, etc.

### SUMMARY OF THE INVENTION

The present invention has been made in an effort to solve the above-described problems associated with prior art, and a first object of the present invention is to provide an unmanned aircraft.

A second object of the present invention is to provide an aircraft controller controlling an unmanned aircraft.

A third object of the present invention is to provide an aircraft control method.

According to an aspect of the present invention to achieve the first object of the present invention, there is provided an unmanned aircraft comprising: a flight control unit for receiving flight information of the aircraft from a position measurement device; a sensor data acquisition unit for acquiring sensor data; a gas measurement unit for measuring gas measurement data; and an on-board computer for receiving a mission of the aircraft from an aircraft controller, controlling the flight control unit to receive the flight information of the aircraft, controlling the sensor data acquisition unit to measure the sensor data, and controlling the gas measurement unit to measure the gas measurement data in the same area where the sensor data is acquired at the moment when the sensor data is acquired.

According to an aspect of the present invention to achieve the second object of the present invention, there is provided an aircraft controller comprising: a second data transmitter/receiver for transmitting a mission of an unmanned aircraft and receiving result information corresponding to the mission of the unmanned aircraft from the unmanned aircraft; and a data processing unit for generating three-dimensional geographic spatial information about air pollution indexes using the result information corresponding to the mission of the unmanned aircraft, visualizing the generated information, and generating the mission of the unmanned aircraft.

According to another aspect of the present invention to achieve the third object of the present invention, there is provided an aircraft control method comprising: receiving result information corresponding to a mission of an aircraft from the aircraft; generating air pollution index values, their distribution, and three-dimensional geographic spatial information about a corresponding ground area using the result information corresponding to the mission of the aircraft and visualizing the generated data; generating a mission command of the aircraft using the result information corresponding to the mission of the aircraft; and displaying the generated three-dimensional geographic spatial information and transmitting the generated mission command to the aircraft.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram of an air pollution monitoring system in accordance with an exemplary embodiment of the present invention;

FIG. 2 is a schematic block diagram showing the internal structure of an air pollution monitoring system in accordance with an exemplary embodiment of the present invention;

FIG. 3 is a schematic block diagram showing the internal structure of a first data transmitter/receiver of an unmanned aircraft in an air pollution monitoring system in accordance with an exemplary embodiment of the present invention;

FIG. 4 is a schematic block diagram showing the internal structure of a second data transmitter/receiver of an aircraft controller in an air pollution monitoring system in accordance with an exemplary embodiment of the present invention;

FIGS. 5 and 6 are diagrams showing examples of three-dimensional real-time air pollution maps generated by a multi-sensor processing unit of a second data transmitter/receiver of an aircraft controller in an air pollution monitoring system in accordance with an exemplary embodiment of the present invention; and

FIG. 7 is a flowchart showing an air pollution monitoring method in accordance with another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

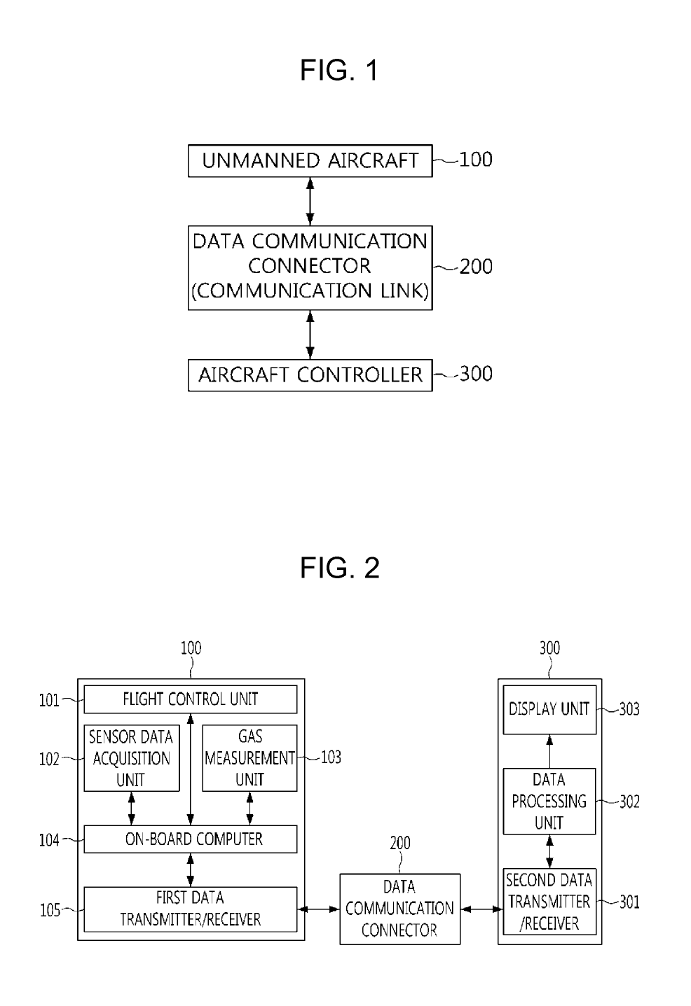

FIG. 1 is a conceptual diagram of an air pollution monitoring system in accordance with an exemplary embodiment of the present invention.

Referring to FIG. 1, an air pollution monitoring system may comprise an unmanned aircraft 100, a data communication connector 200, and an aircraft controller 300.

The unmanned aircraft 100 flies over a ground area, where emission of air pollutants is expected, to collect air pollution data, geographic spatial information of the corresponding ground area, and aircraft status information in real time and to transmit the air pollution data, the geographic spatial information of the corresponding ground area, and the aircraft status information collected in real time to the aircraft controller 300 through the data communication connector 200 in real time.

The data communication connector 200 transmits the air pollution data, the geographic spatial information of the corresponding ground area, and the aircraft status information collected in real time by the unmanned aircraft 100 flying over the ground area, where the emission of air pollutants is expected, to the aircraft controller 300. Moreover, the aircraft controller 300 transmits a mission command of the aircraft or a command for the aircraft, which is determined based on the aircraft status information received from the unmanned aircraft 100, to the unmanned aircraft 100.

The aircraft controller 300 receives the air pollution data, the geographic spatial information of the corresponding ground area, and the aircraft status information collected in real time by the unmanned aircraft 100 through the data communication connector 200, generates air pollution index values, their distribution, and three-dimensional geographic spatial information about the corresponding ground area in real time using the received information, and visualizes the generated data, and stores the corresponding data.

Moreover, the aircraft controller 300 transmits a mission command of the aircraft or a command for the aircraft, which is determined based on the aircraft status information, which is received from the unmanned aircraft 100 through the data communication connector 200, to the unmanned aircraft 100 through the data communication connector 200 so as to remotely control the unmanned aircraft 100, thereby constructing an effective and stable real-time air pollution monitoring system.

Next, the internal structure of the air pollution monitoring system in accordance with the exemplary embodiment of the present invention will be described in detail with reference to FIG. 2.

FIG. 2 is a schematic block diagram showing the internal structure of the air pollution monitoring system in accordance with the exemplary embodiment of the present invention.

Referring to FIG. 2 the air pollution monitoring system may comprise the unmanned aircraft 100, the data communication connector 200, and the aircraft controller 300. The unmanned aircraft 100 may comprise a flight control unit 101, a sensor data acquisition unit 102, a gas measurement unit 103, an on-board computer 104, and a first data transmitter/receiver 105. The aircraft controller 300 may comprise a second data transmitter/receiver 301, a data processing unit 302, and a display unit 303.

The flight control unit 101 collects the geographic spatial information of the ground area corresponding to the air pollution data at a specific time and place and receives the aircraft status information while continuously controlling the position and posture of the unmanned aircraft 100 using GPS (Global Positioning System)/INS (Inertia Navigation System) and Gimbal devices mounted on a platform of the unmanned aircraft 100.

The sensor data acquisition unit 102 receives aerial images and laser scanner data from a digital aerial camera and a laser scanner mounted on the platform of the unmanned aircraft 100. Here, the sensor data acquisition unit 102 comprises the digital aerial camera and the laser scanner, which are installed on a camera mount of the unmanned aircraft 100. The sensor data acquisition unit 102 receives the digital aerial images and the laser scanner data to be used to three-dimensionally display the real-time air pollution data.

The gas measurement unit 103 is provided in a manner that a wireless multi-gas measurement unit is connected to the on-board computer 104 and then installed on the camera mount of the unmanned aircraft 100. Then, at the moment when the aerial images and the laser scanner data are received from the digital aerial camera and the laser scanner mounted on the platform of the unmanned aircraft 100, the gas measurement unit 103 measures gas measurement data from the corresponding ground area. The wireless multi-gas measurement unit simultaneously measures sulfurous acid gas (SO₂), carbon monoxide (CO), carbon dioxide (CO₂), find dusts (PM-10), ozone (O₃), lead (Pb), etc. Moreover, the wireless multi-gas measurement unit uses a lithium-ion battery as an auxiliary power source and AC power mounted in the on-board computer 104 as a main power source.

As such, an RF wireless communication system based on the unmanned aircraft is connected to the portable multi-gas measurement unit for measuring multiple gases, and thus it is possible to efficiently monitor and manage the air pollution using the wireless data transmission system in a disaster site which is dangerous and difficult to access, in a large scale industrial facility which generates harmful gas, etc.

That is, at the moment when safe monitoring of disasters such as gas leakage at a public facility, fire-fighting and emergency rescue, etc. is required, the wireless communication system based on the unmanned aircraft, which simultaneously measures both the air pollution data and the three-dimensional geographic information, is effective against such conditions. Moreover, the wireless communication system based on the unmanned aircraft is effective in the monitoring of military operations for chemical warfare and the monitoring of large scale waste treatment and landfill sites.

When the first data transmitter/receiver 105 receives the mission command of the aircraft or the command for the aircraft from the aircraft controller 300, the on-board computer 104 controls the flight control unit 101, the sensor data acquisition unit 102, and the gas measurement unit 103 to perform a flight mission and a data acquisition process.

First, when the first data transmitter/receiver 105 receives the mission command of the aircraft or the command for the aircraft from the aircraft controller 300, the on-board computer 104 controls the unmanned aircraft 100 to fly over the ground area, where the emission of air pollutants is expected, and to collect the air pollution data, the geographic spatial information of the corresponding ground area, and the aircraft status information in real time.

Second, when the first data transmitter/receiver 105 receives the mission command of the aircraft or the command for the aircraft from the aircraft controller 300, the on-board computer 104 controls the sensor data acquisition unit 102 to receive aerial images and laser scanner data from the digital aerial camera and the laser scanner mounted on the platform of the unmanned aircraft 100. Third, when the first data transmitter/receiver 105 receives the mission command of the aircraft or the command for the aircraft from the aircraft controller 300, the on-board computer 104 controls the gas measurement unit 103 to connect the wireless multi-gas measurement unit for measuring multiple gases to the on-board computer 104 to be installed on the camera mount of the unmanned aircraft 100 and, at the moment when the aerial images and the laser scanner data are received from the digital aerial camera and the laser scanner mounted on the platform of the unmanned aircraft 100, controls the gas measurement unit 103 to measure gas measurement data from the corresponding ground area.

The first data transmitter/receiver 105 transmits a high frequency RF signal of C-band received from the aircraft controller 300 to the on-board computer 104 through an antenna unit 310 installed in the body of the unmanned aircraft 100, which will be described later. Moreover, the first data transmitter/receiver 105 converts the data received from the on-board computer 104 or the measured data into a high frequency RF signal and transmits the converted signal to the aircraft controller 300.

The second data transmitter/receiver 301 receives the high frequency RF signal of C-band from the first data transmitter/receiver 105 of the unmanned aircraft 100 through the data communication connector 200. Moreover, the second data transmitter/receiver 301 transmits the mission command of the aircraft or the command for the aircraft, which is received from the data processing unit 302 and is used to control the unmanned aircraft 100 and the sensors and equipments mounted in the unmanned aircraft 100, to the first data transmitter/receiver 105 through the data communication connector 200 via the antenna unit 310.

The data processing unit 302 generates air pollution index values, their distribution, and three-dimensional geographic spatial information about the ground area, where the emission of air pollutants is expected, in real time using the air pollution data and the geographic spatial information of the corresponding ground area, which are received from the second data transmitter/receiver 301 connected via a serial interface, and visualizes the generated data, and stores the corresponding data in a database. Moreover, the data processing unit 302 transmits the mission command of the aircraft or the command for the aircraft, which is determined using the aircraft status information from the second data transmitter/receiver 301, to the first data transmitter/receiver 105. The display unit 303 displays the three-dimensional geographic spatial information, which is received from the data processing unit 302, in real time.

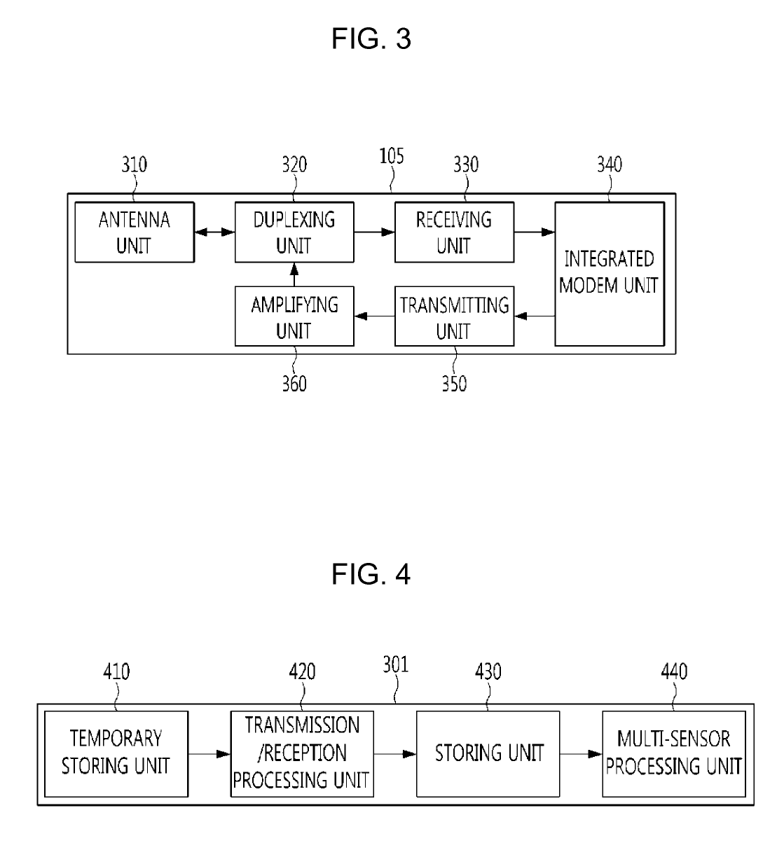

Next, the internal structure of the first data transmitter/receiver 105 of the unmanned aircraft 100 in the air pollution monitoring system in accordance with the exemplary embodiment of the present invention will be described in detail with reference to FIG. 3.

FIG. 3 is a schematic block diagram showing the internal structure of the first data transmitter/receiver of the unmanned aircraft in the air pollution monitoring system in accordance with the exemplary embodiment of the present invention.

Referring to FIG. 3, the first data transmitter/receiver 105 may comprise the antenna unit 310, a duplexing unit 320, a receiving unit 330, an integrated modem unit 340, a transmitting unit 350, and an amplifying unit 360.

The antenna unit 310 is installed in the body of the unmanned aircraft 100. Moreover, the antenna unit 310 may be in a receiving mode or a transmitting mode by the control of the duplexing unit 320. First, when the antenna unit 310 is in the receiving mode by the control of the duplexing unit 320, the antenna unit 310 receives the high frequency RF signal of C-band for the mission command of the aircraft or the command for the aircraft, which is transmitted from the aircraft controller 300 through the data communication connector 200 and is used to control the unmanned aircraft 100 and the sensors and equipments mounted in the unmanned aircraft 100. On the contrary, when the antenna unit 310 is in the transmitting mode by the control of the duplexing unit 320, the antenna unit 310 transmits the signal amplified to a transmittable RF signal by the amplifying unit 360 to the aircraft controller 300 through the data communication connector 200.

The duplexing unit 320 can switch the mode of the antenna unit 310 to the receiving mode or the transmitting mode. First, after switching the mode of the antenna unit 310 to the receiving mode, the duplexing unit 320 allows the antenna unit 310 to transmit the high frequency RF signal of C-band for the mission command of the aircraft or the command for the aircraft, which is received from the aircraft controller 300 through the data communication connector 200 and is used to control the unmanned aircraft 100 and the sensors and equipments mounted in the unmanned aircraft 100, to the receiving unit 330. On the contrary, after switching the mode of the antenna unit 310 to the transmitting mode, the duplexing unit 320 allows the antenna unit 310 to transmit the signal amplified to a transmittable RF signal by the amplifying unit 360 to the aircraft controller 300 through the data communication connector 200. That is, the duplexing unit 320 serves as a filter for switching the antenna unit 310 to a receiver or a transmitter under the wireless communication environment using the unmanned aircraft 100, and thus the receiver and the transmitter having different frequencies serve as an intermediate filter for sharing one antenna in an efficient manner.

The receiving unit 330 receives the high frequency RF signal of C-band for the mission command of the aircraft or the command for the aircraft, which is transmitted from the aircraft controller 300 through the data communication connector 200 and is used to control the unmanned aircraft 100 and the sensors and equipments mounted in the unmanned aircraft 100, through the duplexing unit 320, converts the received high frequency RF signal of C-band into a baseband signal, i.e., a very low frequency signal, and transmits the converted signal to the integrated modem unit 340.

When the antenna unit 310 is in the receiving mode by the control of the duplexing unit 320, the integrated modem unit 340 receives the baseband signal converted by the receiving unit 330, converts the received signal into a high frequency RF signal of C-band, and transmits the converted signal to the transmitting unit 350. Here, the integrated modem unit 340 stores the converted signal in the on-board computer 104. Therefore, as mentioned above, the on-board computer 104 controls the flight control unit 101 to control the flight of the unmanned aircraft 100 using the aircraft status information, controls the gas measurement unit 103 to measure the air pollution data, and controls the sensor data acquisition unit 102 to obtain the digital aerial images and the laser scanner data.

On the contrary, when the antenna unit 310 is in the transmitting mode by the control of the duplexing unit 320, the integrated modem unit 340 receives flight information including GPS/INS data of the unmanned aircraft 100, gas measurement data as the air pollution data, and sensor data including the digital aerial images and the laser scanner data, which are stored in the on-board computer 104, through the serial interface which supports a speed 1,000 Mbps or higher, and converts the received baseband data into a high frequency RF signal of C-band.

The transmitting unit 350 receives the high frequency RF signal of C-band converted by the integrated modem unit 340, converts the received high frequency RF signal of C-band into a higher frequency RF signal of C-band, and transmits the converted signal to the amplifying unit 360. The amplifying unit 360 receives the high frequency RF signal of C-band from the transmitting unit 350 and amplifies the high frequency RF signal of C-band. Then, the amplified signal is transmitted to the antenna unit 310, which is set to the transmitting mode by the duplexing unit 320, and then transmitted to the aircraft controller 300 through the data communication connector 200.

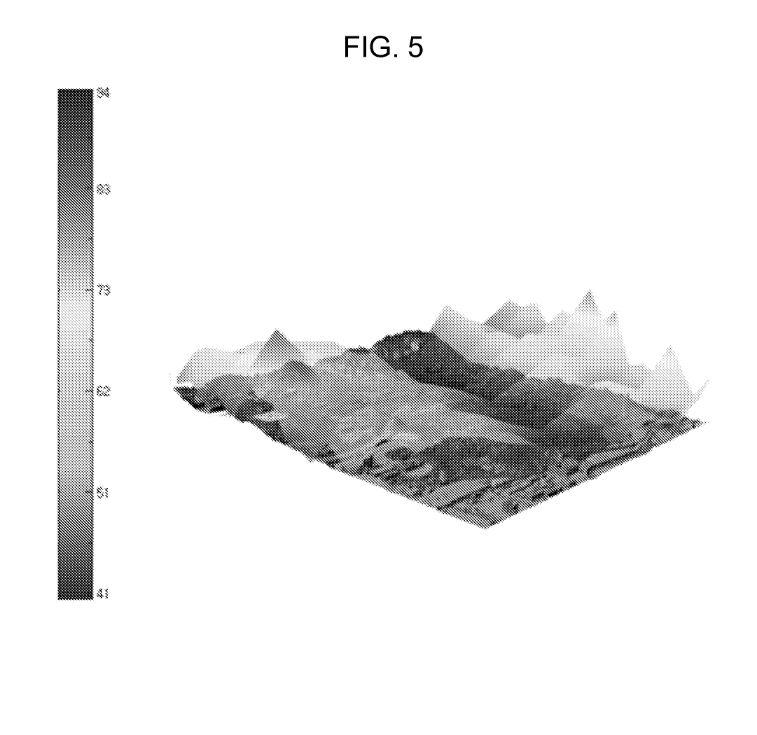

Next, the internal structure of the second data transmitter/receiver 301 of the aircraft controller 300 of the air pollution monitoring system in accordance with the exemplary embodiment of the present invention will be described in detail with reference to FIG. 4.

FIG. 4 is a schematic block diagram showing the internal structure of the second data transmitter/receiver of the aircraft controller in the air pollution monitoring system in accordance with the exemplary embodiment of the present invention.

Referring to FIG. 4, the second data transmitter/receiver 301 may comprise a temporary storing unit 410, a transmission/reception processing unit 420, a storing unit 430, and a multi-sensor processing unit 440.

The temporary storing unit 410 stores the flight information including the GPS/INS data, the gas measurement data as the air pollution data, and the sensor data including the digital aerial images and the laser scanner data, which are received from the first data transmitter/receiver 105 through the data communication connector 200, in real time. Here, the temporary storing unit 410 stores the flight information including the GPS/INS data, the gas measurement data as the air pollution data, and the sensor data including the digital aerial images and the laser scanner data, which are received from the first data transmitter/receiver 105 through the data communication connector 200, in an uncompressed state.

The transmission/reception processing unit 420 is connected to the multi-sensor processing unit 440 and transmits the flight information including the GPS/INS data, the gas measurement data as the air pollution data, and the sensor data including the digital aerial images and the laser scanner data, which are received from the temporary storing unit 410, to the storing unit 430 and the multi-sensor processing unit 440. Here, the transmission/reception processing unit 420 may transmit the flight information including the GPS/INS data, the gas measurement data as the air pollution data, and the sensor data including the digital aerial images and the laser scanner data to the storing unit 430 and the multi-sensor processing unit 440 in a compressed state or in an uncompressed state.

The multi-sensor processing unit 440 performs an image formation process and a camera calibration process at the same time on the air pollution data such as sulfurous acid gas (SO₂), carbon monoxide (CO), carbon dioxide (CO₂), find dusts (PM-10), ozone (O₃), lead (Pb), etc., which are received from the multi-gas measurement unit of the mobile gas measurement unit 103 mounted on the platform of the unmanned aircraft 100, and the digital aerial images and the laser scanner data, which are received from the sensor data acquisition unit 102, and then processes the resulting data by applying direct orientation to time-encoded data, which are output from the transmission/reception processing unit 420, using the GPS/Ins data received from the unmanned aircraft 100. The multi-sensor processing unit 440 can automatically and rapidly perform digital elevation model (DEM) and orthophoto generation without the manual input of tie points and ground control points (GCP).

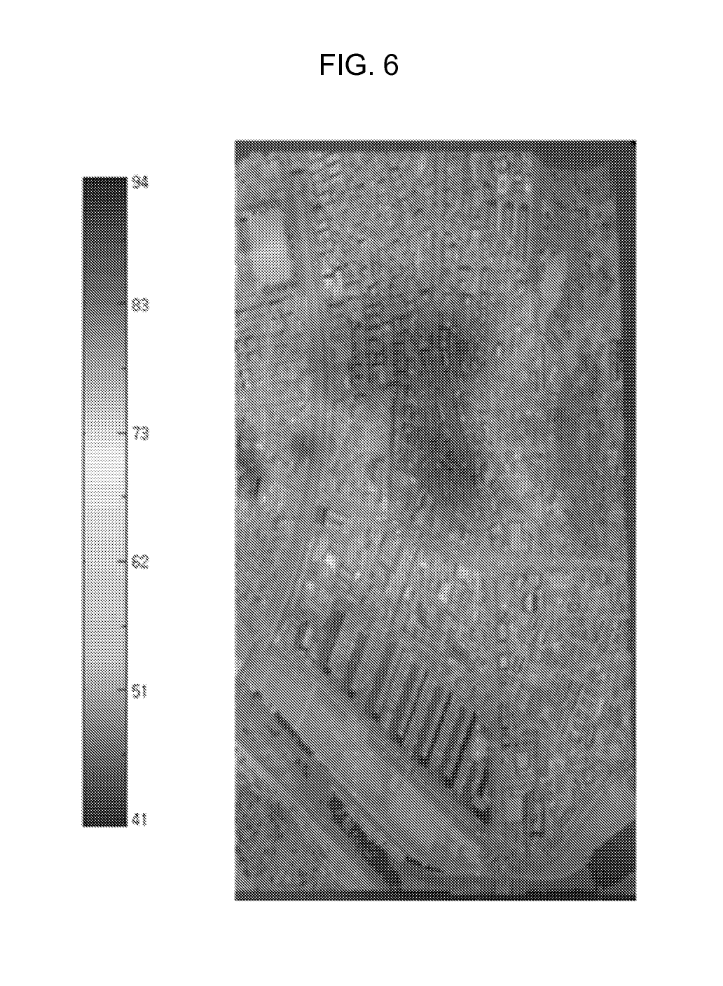

Next, examples of three-dimensional real-time air pollution maps generated by the multi-sensor processing unit 440 of the second data transmitter/receiver 301 of the aircraft controller 300 in the air pollution monitoring system in accordance with the exemplary embodiment of the present invention will be described in detail with reference to FIGS. 5 and 6.

FIGS. 5 and 6 are diagrams showing examples of three-dimensional real-time air pollution maps generated by the multi-sensor processing unit of the second data transmitter/receiver of the aircraft controller in the air pollution monitoring system in accordance with the exemplary embodiment of the present invention.

Referring to FIG. 5, a geocoding process, in which the air pollution index values as the air pollution data such as the concentrations of sulfurous acid gas (SO₂), carbon monoxide (CO), carbon dioxide (CO₂), find dusts (PM-10), ozone (O₃), and lead (Pb), are superimposed over the laser scanner data collected in real time by the unmanned aircraft 100 and a DEM layer generated with the aerial images to match the geographic location coordinates, is performed. At the moment when the digital aerial camera and the laser scanner mounted on the platform of the unmanned aircraft 100 obtain the data on the ground area, the multi-gas measurement unit measures the concentrations of sulfurous acid gas (SO₂), carbon monoxide (CO), carbon dioxide (CO₂), find dusts (PM-10), ozone (O₃), lead (Pb), etc. in the atmosphere corresponding to the ground area and generates an air pollution data layer in real time.

Referring to FIG. 6, the generated air pollution data layer is superimposed on the laser scanner data collected in real time by the unmanned aircraft 100 and an orthophoto layer generated with the aerial images.

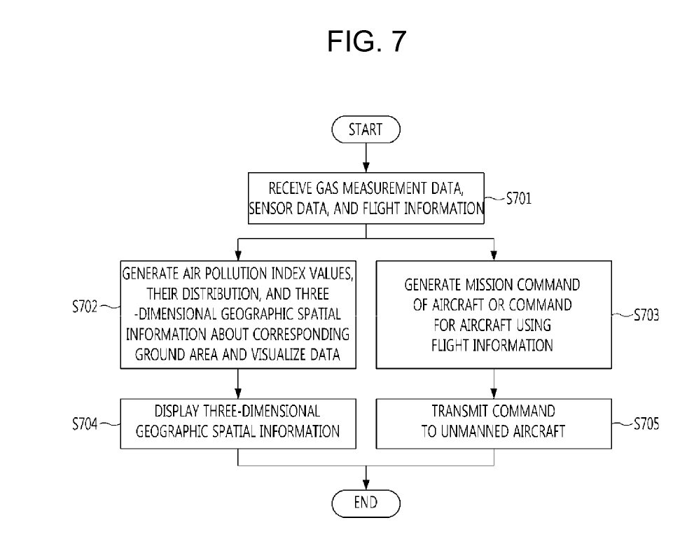

Next, air pollution monitoring method in accordance with another exemplary embodiment of the present invention will be described in more detail with reference to FIG. 7.

FIG. 7 is a flowchart showing an air pollution monitoring method in accordance with another exemplary embodiment of the present invention.

Referring to FIG. 7, an aircraft controller receives gas measurement data, sensor data, and flight information from an unmanned aircraft through a data communication connector (S701). A flight control unit of the unmanned aircraft collects geographic spatial information of a ground area corresponding to the air pollution data at a specific time and place and receives aircraft status information while continuously controlling the position and posture of the unmanned aircraft using GPS/INS and Gimbal devices mounted on a platform of the unmanned aircraft. Moreover, a sensor data acquisition unit of the unmanned aircraft receives aerial images and laser scanner data from a digital aerial camera and a laser scanner mounted on the platform of the unmanned aircraft. Here, the sensor data acquisition unit comprises the digital aerial camera and the laser scanner, which are installed on a camera mount of the unmanned aircraft. The sensor data acquisition unit receives the digital aerial images and the laser scanner data to be used to three-dimensionally display the real-time air pollution data.

A gas measurement unit is provided in a manner that a wireless multi-gas measurement unit is connected to an on-board computer and then installed on the camera mount of the unmanned aircraft. Then, at the moment when the aerial images and the laser scanner data are received from the digital aerial camera and the laser scanner mounted on the platform of the unmanned aircraft, the gas measurement unit measures the gas measurement data from the corresponding ground area. The wireless multi-gas measurement unit simultaneously measures the concentrations of sulfurous acid gas (SO₂), carbon monoxide (CO), carbon dioxide (CO₂), find dusts (PM-10), ozone (O₃), lead (Pb), etc. Moreover, the wireless multi-gas measurement unit uses a lithium-ion battery as an auxiliary power source and AC power mounted in the on-board computer as a main power source.

The aircraft controller generates air pollution index values, their distribution, and three-dimensional geographic spatial information about the corresponding ground area in real time using the gas measurement data and the sensor data and visualizes the generated data (S702). The aircraft controller generates a mission command of the aircraft or a command for the aircraft using the flight information (S703). The aircraft controller displays the generated three-dimensional geographic spatial information in real time (S704) and transmits the generated command to the unmanned aircraft (S705).

As described above, according to the air pollution monitoring method and system of the present invention, it is possible to automatically measure and accurately analyze the air pollution data in the corresponding site at the time of the occurrence of an urgent situation without space and time limits, and thus it is possible to trace back the origins of the air pollution. Moreover, it is possible to display the air pollution data through a substantially three-dimensional geographic spatial information layer, thereby monitoring the air pollution in real time. Further, the operation system of the unmanned aircraft, which is mainly used in military surveillance, can be used in the air pollution monitoring system, and thus it is possible to maximize the operation of the unmanned aircraft and the utilization of the GIS data such as DEM data and orthophoto data obtained by the unmanned aircraft. Meanwhile, it is necessary to determine the extent, pattern, and distribution of the damage in a disaster site which is dangerous and difficult to access. According to the air pollution monitoring method and system of the present invention, it is possible to monitor the air pollution in real time using the three-dimensional spatial information.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. An unmanned aircraft comprising:
a flight control unit for receiving flight information of the aircraft from a position measurement device;
a sensor data acquisition unit for acquiring sensor data;
a gas measurement unit for measuring gas measurement data; and
an on-board computer for receiving a mission of the aircraft from an aircraft controller, controlling the flight control unit to receive the flight information of the aircraft, controlling the sensor data acquisition unit to measure the sensor data, and controlling the gas measurement unit to measure the gas measurement data in the same area where the sensor data is acquired at the moment when the sensor data is acquired.

2. The unmanned aircraft of claim 1, further comprising a first data transmitter/receiver for transmitting the gas measurement data, the sensor data, and the flight information to the aircraft controller and receiving the mission of the aircraft from the aircraft controller.

3. The unmanned aircraft of claim 2, wherein the first data transmitter/receiver comprises:
an antenna unit for receiving a high frequency signal from the aircraft controller when the antenna unit is in a receiving mode and transmitting a high frequency signal to the aircraft controller when the antenna unit is in a transmitting mode;
a duplexing unit for setting the state of the antenna unit to the receiving mode or the transmitting mode;
a receiving unit for converting the high frequency signal received from the antenna unit through the duplexing unit;
an integrated modem unit for converting the converted high frequency signal into a baseband signal when the antenna unit is in the receiving mode and converting the baseband signal into a high frequency signal when the antenna unit is in the transmitting mode;
a transmitting unit for converting the converted baseband signal into a high frequency signal; and
an amplifying unit for amplifying the converted high frequency signal and transmitting the amplified signal to the aircraft controller.

4. The unmanned aircraft of claim 1, wherein the flight control unit receives geographic spatial information of a ground area, from which the gas measurement data is measured, and aircraft status information.

5. The unmanned aircraft of claim 1, wherein the sensor data acquisition unit receives digital aerial images and laser scanner data to be used to three-dimensionally display the gas measurement data measured in real time.

6. An aircraft controller comprising:
a second data transmitter/receiver for transmitting a mission of an unmanned aircraft and receiving result information corresponding to the mission of the unmanned aircraft from the unmanned aircraft; and
a data processing unit for generating three-dimensional geographic spatial information about air pollution indexes using the result information corresponding to the mission of the unmanned aircraft, visualizing the generated information, and generating the mission of the unmanned aircraft.

7. The aircraft controller of claim 6, wherein the data processing unit performs an image formation process and a camera calibration process using the sensor data, generates the three-dimensional geographic spatial information by applying direct orientation using the flight information, and visualizes the generated information.

8. The aircraft controller of claim 6, wherein the result information corresponding to the mission of the unmanned aircraft comprises gas measurement data, sensor data, and flight information.

9. The aircraft controller of claim 8, wherein the flight information comprises geographic spatial information of a ground area and aircraft status information.

10. The aircraft controller of claim 8, wherein the sensor data comprises digital aerial images and laser scanner data to be used to three-dimensionally display the gas measurement data measured in real time.

11. An aircraft control method comprising:
receiving result information corresponding to a mission of an aircraft from the aircraft;
generating air pollution index values, their distribution, and three-dimensional geographic spatial information about a corresponding ground area using the result information corresponding to the mission of the aircraft and visualizing the generated data;
generating a mission command of the aircraft using the result information corresponding to the mission of the aircraft; and
displaying the generated three-dimensional geographic spatial information and transmitting the generated mission command to the aircraft.

12. The aircraft control method of claim 11, wherein the visualizing the generated data comprises performing an image formation process and a camera calibration process using the sensor data, generating the three-dimensional geographic spatial information by applying direct orientation using flight information, and visualizing the generated information.

13. The aircraft control method of claim 11, wherein the result information corresponding to the mission of the aircraft comprises gas measurement data, sensor data, and flight information.

14. The aircraft control method of claim 13, wherein the flight information comprises geographic spatial information of a ground area and aircraft status information.

15. The aircraft control method of claim 13, wherein the sensor data comprises digital aerial images and laser scanner data to be used to three-dimensionally display the gas measurement data measured in real time.
